(19) United States
(12) Patent Application Publication
(10) Pub. No.: US 2008/0041915 A1
(43) Pub. Date: Feb. 21, 2008

(54) Nail gun reload indicator

(76) Inventors: James Morris Boyer, Saint Simons Island, GA (US); Brandee Beth Boyer, Saint Simons Island, GA (US)

Correspondence Address: BRANDEE BETH BOYER, 205 PELICAN PLACE, ST. SIMONS ISL., GA, 31522, US

(21) Appl. No.: 11/799,089

(22) Filed: May 1, 2007

Related U.S. Application Data
(60) Provisional application No. 60/837,836, filed on Aug. 16, 2006.

(51) Int. Cl. B25C 7/00

(52) U.S. Cl. 227/156; 340/384.7; 340/815.45

(57) ABSTRACT

The “nail gun reload indicator” gives the user an alarm when his/her nail supply is near depletion. The indicator beeps and a light comes on to make the user aware of the need to replenish his/her nail supply, thus creating a more effective product with the nail gun of choice. The invention will encompass the idea of alerting the user of a nail gun of near depletion of nails as indicated by any source as technology may advance to allow ease of use. This invention provides an improvement to an existing product, a standard nail gun. The improvement is an attachment or can be placed inside the standard nail gun and allows an alarm to sound, indicating when the supply of nails is almost depleted. Therefore, allowing a supply of nails into the nail gun, instead of haphazardly firing, until there are no more nails. The invention of the “nail gun reload indicator” is explained therein to provide a simple understanding of said invention, but is should be noted that this idea applies to any such variety of any device that may achieve the same end result. Let it be noted that for the purposes of this application, the term “nail gun” will apply to all fasteners, staplers and trim guns.

### CROSS-REFERENCE TO RELATED PATENT APPLICATIONS

This patent application is a continuation-in-part of U.S. patent application No. 60/837,836 filed on Aug. 16, 2006, and entitled “nail gun reload indicator”, which is incorporated in its entirety herein by this reference.

### FIELD OF INVENTION

According to the major aspects and broadly stated, the present invention generally related to the field of power tools, and particularly to a gauge for determining the need to reload a nail gun device. In the event that a nail gun reaches near the end of a round of nails, the nail gun reload indicator device sounds an alarm and emits a light to warn the user that the nail gun will soon be out of nails.

### BACKGROUND OF THE INVENTION

The nail gun reload indicator saves time and money, while increasing efficiency and safety in the work place. Efficiency and safety are the most important aspects of this invention. The nail gun reload indicator will revolutionize the way the user is able to adapt their nail gun to work situations. The safety aspects and time saving will be immediately realized by the experienced user.

Time and effort are saved in the work place when the nail gun reload indicator is used on a nail gun. An example of saving time and money is evident when the user of a nail gun is aware of the nail quantity in the nail gun before attempting to secure a heavy load. The nail guns used today do not allow the user to know a nail supply is exhausted. If the nail gun user is made aware of the absence of nails before a task, much time and aggravation can be saved.

The “nail gun reload indicator” can decrease dangerous conditions in the work place. This added feature allows the user to know if the nail gun is firing without expending nails. The user may assume a wall or roof component is properly nailed, when in fact there are insufficient nails in the magazine. Improperly supported heavy objects over head create a danger in the workplace, that is eliminated with the “nail gun reload indicator”.

The “nail gun reload indicator” can eliminate the dangerous conditions involved in roofing and the installation of decking. Roof pitches and often exceed a 45 degree angle and may take a great deal of strength and dexterity to move a heavy piece of plywood from the ground to the roof. To place the first run of plywood on the rafters is usually a three man operation. Two men place the plywood in position with a great deal of difficulty and a third man quickly “tacks” the plywood in place. It is important to be quick in this action to keep the plywood from sliding off of the roof. If the nail gun is empty, it increases the time the plywood must be manually held in place, while the nail gun is reloaded, increasing worker fatigue.

### SUMMARY OF THE INVENTION

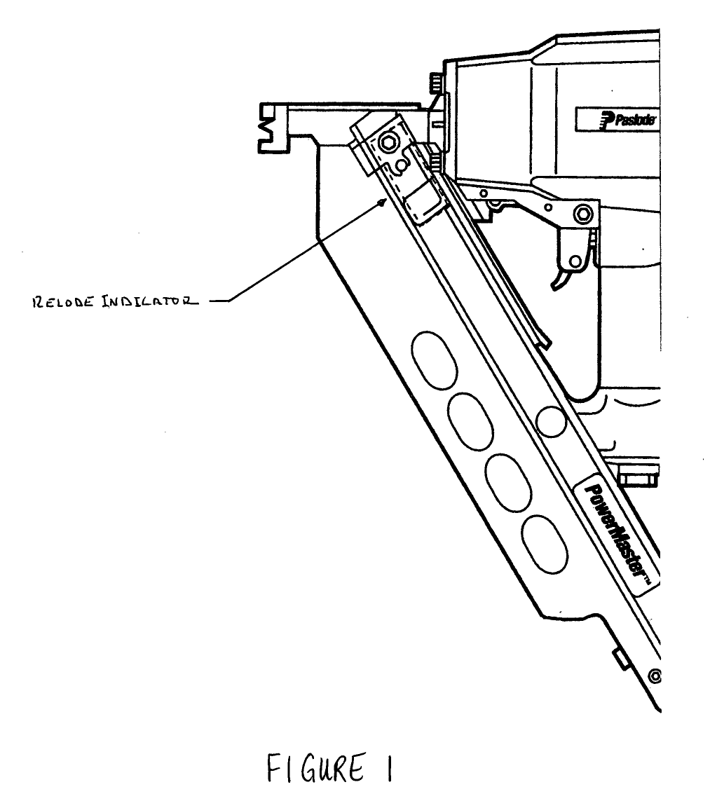

For the purpose of this summary. The nail gun reload indicator is shown on a Paslode™ framing gun. For the interpretation of the “nail gun reload indicator”, please refer to FIG. 1A-E.

The following describes, briefly, the action involved in making the “nail gun reload indicator” successful in and of itself. There are many nail fasteners and staplers on the market today. While each brand differs in design, the basic principle for holding and advancing a fastener into the firing sleeve, via a constant force spring, is the same.

These principle parts consists of a magazine (to hold the fastener) FIG. 1(A) and a constant force spring (B), for maintaining constant forward tension on a fastener supply and advancing nails into the firing sleeve (C). Where upon pulling the actuator or trigger of a nail gun, a burst of air is released, driving a piston down on to the nail that is positioned in the firing sleeve (C). Thus, forcing the nail into the desired material. The constant force spring (B) is a coiled band of steel attached to the exit end of the magazine (A). Attached to the opposite end of this band is a pusher (D) (not shown) which presses nails forward and is pulled back manually with a pusher handle (E) into a locking position. Nails are then loaded into a magazine (A). This pusher is then released where forward tension is maintained advancing fasteners into their firing position.

The pusher is attached internally in the magazine to the constant force spring (B) (not shown). The pusher handle is attached externally of the magazine to the pusher.

The constant force spring forces nails forward into the magazine as they are expended. The constant force spring returns to it's coiled position at the exit end of the magazine bringing the attached pusher and pusher handle to the exit end of the magazine.

The forward advancement of the pusher handle (common to all fasteners) is the triggering mechanism for the alarm on the reload indicator. The pusher handle moves forward as nails are expended, bringing it into contact with a rigidly mounted compact mini switch, which will cause an alarm to sound as the nail source is depleted or through an adjustment in the push button's plunger, nearly depleted.

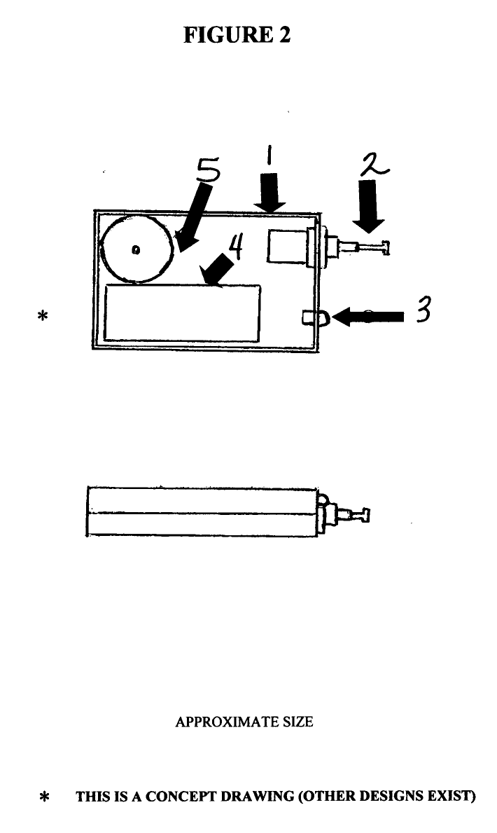

For purposes of explaining the components of the nail gun reload indicator, refer to FIG. 2 (1-5). The nail gun reload indicator, consists of a casing (1), push button switch (2), L.E.D. (3), battery and holder (4) and a buzzer (5).

The casing (1), consists of a compact housing agent for holding all of the components of the nail gun reload indicator in place.

The push button switch (2), is the device that triggers the alarm on the nail gun reload indicator.

The L.E.D. (3), consists of a light to alert the user of a nail gun of nail depletion. The light emitting diode (L.E.D) is a bright light that should be easily seen by the nail gun user.

The battery and holder (4), is used to power the nail gun reload indicator. This concept drawing shows a 12-volt battery, but the invention is not limited to using this type of power.

The buzzer (5), is a device of alarming the user of the nail gun reload indicator, of nail depletion. The sound should be loud enough to be heard under loud construction conditions.

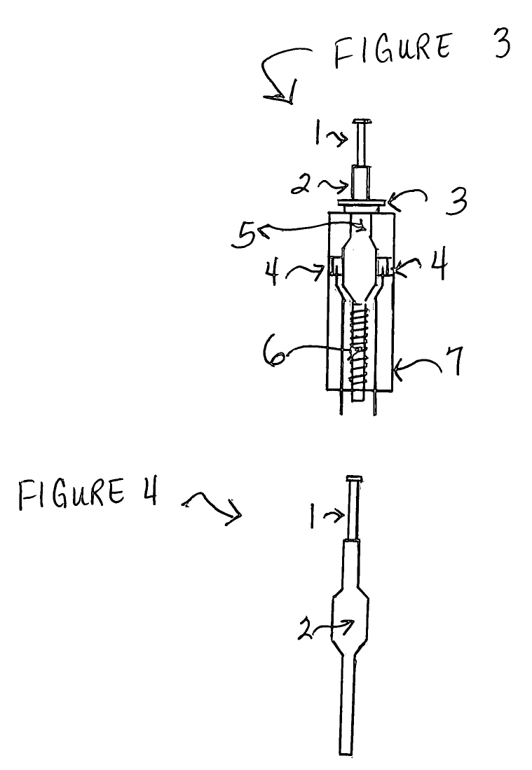

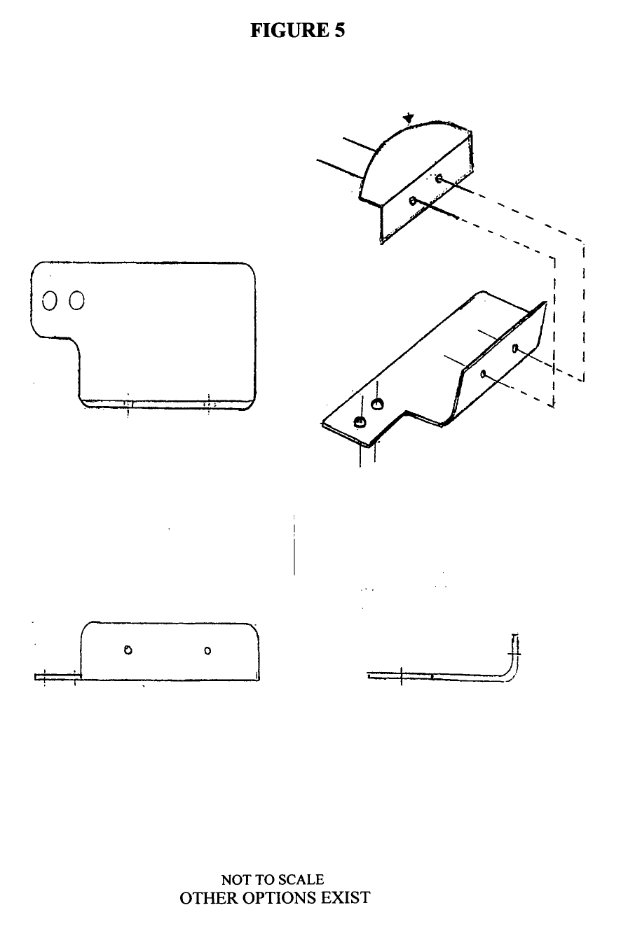

For purposes of explaining the push button, in detail, refer to FIG. 3 (1-7) and for the adjustable plunger, FIG. 4 (1-2). The push button on the nail gun reload indicator consists of a plunger extension with mail thread (1), plunger with female thread (2), fastening nut with a lock washer (3), contact band (4), contact (5), spring (6) and switch casing (7). The switch plunger (2) is located beyond the maximum forward position of the pusher handle (1). From this point, the plunger extension can be adjusted, as to allow the plunger to travel through the body of the switch. This will eliminate damage to the switch, in case of sudden release of the constant force spring (6).

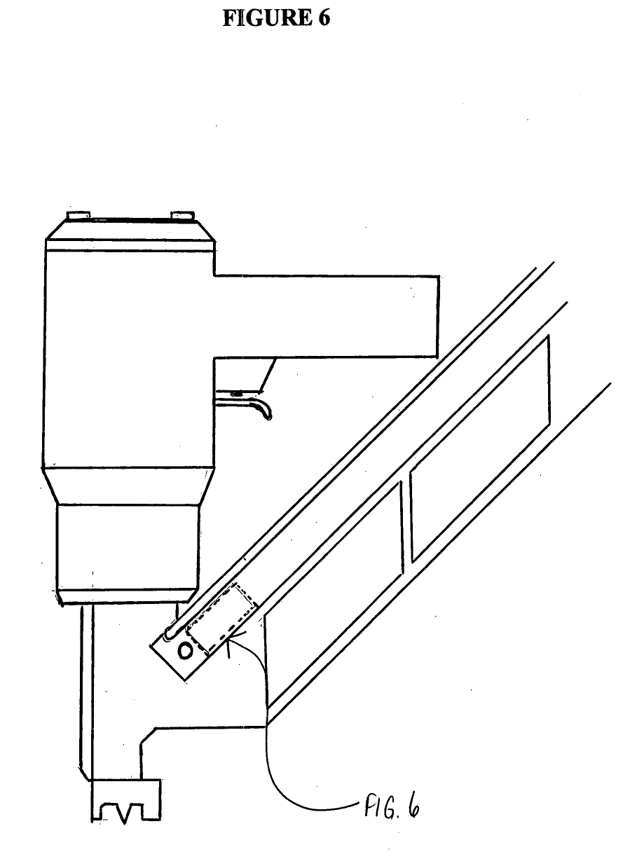

For purposes of describing the embodiments of the bracket for mounting the nail gun reload indicator, refer to FIG. 5.

For purposes of describing the nail gun reload indicator, as mounted to nail gun, refer to FIG. 1. This picture show the nail gun reload indicator mounted to the Paslode™ nail gun.

It is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to specific order or hierarchy presented.

It is believed that the present invention and many of its attendant advantages will be understood by forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof.

We claim:

1. The “nail gun reload indicator” will eliminate the dangers and inconvenience related to the inability of the user of a nail gun to recognize when the nails in the nail gun need to be reloaded. The achievement of the end result of the nail gun reload indicator are not limited to those mentioned in this patent application. The end result will be to alert the user of a nail gun as to when there is a need to replenish the supply of nails in the nail gun.

2. The “nail gun reload indicator”, as described in claim 1, can be adapted to all brands of nail guns, framing or trim, pneumatic, electric or power.

3. The “nail gun reload indicator” as described in claim 1, can be made in several different ways, using smaller buzzers and power source, as well as positioning on the nail gun, depending on the nail feed apparatus. The “nail gun reload indicator” can be mounted externally or incorporated into the manufacturing of the gun, relying on the individual engineering for suitable placement.

4. The “nail gun reload indicator”, as described in claim 3, can be activated by laser switch which is mounted on top of the magazine of a nail gun in such a way as to point down on to the fastener head of the nail gun. As the last nails pass the point of light, the laser shines o a switch mounted at a location below and in line with the laser, activating the reload indicator. The laser should be mounted in such way as to be adjustable forward and backward at the desecretion of the user.

5. The “nail gun reload indicator”, as described in claim 3, may also be activated as the laser shines across the fastener supply with a switch opposite it. The laser mounted in such a way as to be adjustable forward and backward in this application. The laser would have to shine on the switch continuously for a predetermined amount of time, due to the spacing of the nails in a clip.

6. The “nail gun reload indicator”, as described in claim 3, may be activated by having a lever switch mounted to the side of the magazine with the lever in contact with the clip of fasteners, thus being held in the off position. As the fasteners are expended, they move beyond the lever switch, releasing an alarm. It should be noted that this application may not be suitable for all brands of nail and trim guns. However, modifications can be made to the magazine of any magazine to accommodate this type of switch.

7. The “nail gun reload indicator”, as described in claim 3, may use a device in the form of a magnetic switch, with another magnet mounted to the push handle. As nails are expended and the push handle moves forward, the magnets are aligned and the reload indicator is activated. The magnet mounted to the magazine should be adjustable forward and backward.

8. The “nail gun reload indicator”, as described in claim 3, may also be activated by a proximity switch. This switch could be mounted on the pusher handle in such a way as to determine the proximity of the pusher handle in relationship to a predetermined point on the magazine. As the nails near depletion, the proximity switch moves forward with the pusher handle, activating the alarm at a predetermined point.

9. The “nail gun reload indicator”, as described in claims 3, 4, 5, 6, 7 and 8, are only examples of getting the same said result, that is alarming the user of a nail gun of the need to replenish his/her nails. Any way of achieving this goal is covered in the said invention, “nail gun reload indicator”.

10. The audio aspect of the reload indicator is to provide the user with an audio alert as to the status of his/her nail supply. The sound emitted should be loud enough to be heard under normal construction noises such as compressors, saws, etc.

11. The audio component, as described in claim 10, can be an electronic tone or buzzer that when sounded emits a continuous alarm.

12. The audio component, as described in claim 10, can emit an intermittent tone or buzz.

13. The audio component, as described in claim 10, can alarm intermittently as nails near depletion, the intermission between sounds lessen until it is continuous when the nails are completely depleted.

14. The visual aspect of the “nail gun reload indicator is to provide the user with a visual alert as to the status of the nail supply.

15. The visual component, as described in claim 14, can be a light emitting diode (L.E.D.). The L.E.D. should be bright enough to be easily noticed by the user. The L.E.D. should be located in an obvious place on the nail gun so the user can see the light being emitted. It is also important for the L.E.D. to be protected from hazardous conditions.

16. The visual component, as described in claim 14, emits a red or orange light, but is not limited to these colors.

17. The visual component, as described in claim 14, emits a continuous light or may blink, but is not limited to this.

18. The visual component, as described in claim 14, can blink with decreased intermissions until it remains continuous at the depletion of the nail supply.

19. The “nail gun reload indicator”, as described in claim 1, can be altered to specifications of the user or manufacturer. The “nail gun reload indicator” is mounted to the outside of the nail gun or can be incorporated to the inside of the nail gun.

20. The “nail gun reload indicator”, as described in claim 19, can be rigidly mounted as reasonably as possible. At the same time, certain components must remain adjustable and accessible. Brackets holding the reload indicator securely in place will be designed for the individual brand of nail gun. The holding bracket can be designed to use existing bolts or screws.

21. The “nail gun reload indicator”, as described in claim 19, can be redesigned to accommodate components with an integrated protective box to house components. A clamping devise can be fixed to the magazine to securely hold the devise in place. The protective housing can be designed with screw or bolt flanges that would bolt on to the magazine of a nail gun.

22. The “nail gun reload indicator”, as described in claim 1, is activated by a triggering mechanism. Regardless of the triggering mechanism, the concept of alerting the user of the depletion of nails remains the same.

23. The “nail gun reload indicator”, as described in claim 22, can be activated by the nails moving to a predetermined point or beyond this point or the push handle moving to a predetermined point or beyond this point.

24. Let it be noted, that any change in the triggering device applied to the said patent of a nail gun reload indicator, does not change the end result of the propose of the device. Therefore, alternate sources could e used to achieve the same end result. The said result being, an alarm alerting the user, the nail supply in a nail gun is near depletion or completely depleted.
